(19) United States
(12) Patent Application Publication
(10) Pub. No.: US 2016/0162125 A1
(43) Pub. Date: Jun. 9, 2016

(54) SYSTEM AND METHOD FOR PROVIDING MEDIA PREVIEW FOR PLAYLISTS

(71) Applicant: Verizon Patent and Licensing Inc., Basking Ridge, NJ (US)

(72) Inventor: Brandon James MARTELLA, Brentwood, CA (US)

(21) Appl. No.: 14/562,315

(22) Filed: Dec. 5, 2014

(51) Int. Cl. G06F 3/0482; G06F 3/0484; G06F 17/30

(52) U.S. Cl. CPC G06F 3/0482; G06F 17/30053; G06F 3/04847; G06F 3/04842

(57) ABSTRACT

An approach is provided for organizing media items in a playlist for playback on the first device based on selection of media items in the second device. The approach involves generating a playlist of one or more media items for playback on a first device. The approach also involves initiating a preview of the one or more media items, one or more other media items, or a combination thereof on one or more second devices, wherein the one or more second devices control a streaming of the playlist to the first device. The approach further involves receiving a voting input for identifying a selected media item from among the one or more media items, the one or more other media items, or a combination thereof based on the preview. The approach also involves modifying the playlist for playback on the first device based on the selected media item.

### BACKGROUND INFORMATION

Media playback (e.g., audio and/or video playback) is a popular activity among consumers and mobile device users. As part of this activity, users often create playlists of media items (e.g., songs, video clips, etc.) to organize the items for playback. However, when a playlist is currently playing on a device, it can be difficult for users to continue to select, add, and/or otherwise modify items in the playlist without interrupting the playback of the playlist. For example, a user may not be familiar with a particular media item from its name (or other descriptor) alone, and may need to preview the media item before deciding to add the item to the current play. However, to initiate the preview, the user may have to interrupt the playback of the currently playlist, thereby disrupting the playback experience. This problem can be particularly complex when multiple users (e.g., with different preferences) are concurrently contributing to and/or modifying the same playlist.

Therefore, there is a need for providing media preview and multi-user coordination for media playlists.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of organizing media items in a playlist for playback on the first device based on selection of media items in the second device, according to one embodiment;

FIG. 2 is a diagram of the components of the arrangement platform 115, according to one embodiment;

FIG. 3 is a flowchart of a process for providing preview of media items in a second device for receiving an input for identifying media items for playback on the first device, according to one embodiment;

FIG. 4 is a flowchart of a process for determining playback order of media items in the playlist based on the voting input, according to one embodiment;

FIG. 5 is a flowchart of a process for collecting media items from one or more content providers, according to one embodiment;

FIG. 6 is a flowchart of a process for uploading selected media item local to the second device to facilitate playback on the first device, according to one embodiment;

FIG. 7A is a diagram that represents a scenario wherein at least one user equipment maneuvers the ranking of certain media items in the playlist of a client device, according to one example embodiment;

FIG. 7B is a diagram that represents a scenario wherein at least one user equipment controls the serving stream from the server to the client device, according to one example embodiment;

FIG. 8 is a user interface diagram that represents a scenario wherein media items are previewed in one or more second devices for modifying a playlist in the first device, according to one example embodiment;

FIG. 9 is a user interface diagram that represents a scenario wherein media items of interest are uploaded from second devices to facilitate playback on the first device, according to one example embodiment;

FIG. 10 is a diagram of a computer system that can be used to implement various exemplary embodiments; and

FIG. 11 is a diagram of a chip set that can be used to implement various exemplary embodiments.

### DESCRIPTION OF THE PREFERRED EMBODIMENT

An apparatus, method, and software for organizing media items in a playlist for playback on the first device based on selection of media items in the second device by one or more users, is described. In the following description, for the purposes of explanation, numerous specific details are set forth in order to provide a thorough understanding of the present invention. As is well known, the present invention may be practiced without these specific details or with an equivalent arrangement. In other instances, well-known structures and devices are shown in block diagram form in order to avoid unnecessarily obscuring the present invention.

As discussed, creating playlists for media playback is an important activity for many users. Although traditional playlist creation historically has been available to users, an increasingly complex media service and devices environment can make it more challenging and complex process for users. For example, modern users have access to multiple content types (e.g., audio and/or video) from multiple sources (e.g., streamlining, local content, cloud content, etc.) across multiple devices (e.g., smartphones, tablets, smart televisions, personal computers, dedicated media appliances, etc.). Moreover, certain environments enable multiple users to collaboratively create playlists for playback in a shared environment, thereby increasing the complexity and/or potential for disruption of playlist creation process. Accordingly, when operating in these types of environments, traditional playlist creation processes may result in playback interruption (e.g., to preview a media item before adding it to a playlist), unavailability of selected media items (e.g., caused by lack of access to selected media providers or sources), conflicting playlist priorities or selections (e.g., when multiple users make conflicting changes to a playlist), etc.

Another problem arises from the sheer volume of media (e.g., music) and media sources (e.g., both streamlining and non-streaming sources) available to modern users. For example, media playback devices often allow users access to a large collection of music. So, in many cases, a user might recognize media items (e.g., songs) from hearing or viewing the items, but not necessarily from seeing a listing of the media item's name. In other words, when a user is listening to music he/she may not correlate the title of a song with the corresponding music. Accordingly, when a user searches for a desired song by previewing every songs in the playlist, and then deleting or adding songs, this process can interrupt playback of a currently active playlist. As a result, there is a need for a method that assists users in selecting media items of their choice without disrupting currently playing media items.

In one embodiment, the system 100 performs one or more functions associated with organizing media items in a playlist for playback on the first device based on selection of media items in the second device by one or more users. The system 100 enables a user to choose a media item, preview the media item, and if the user likes the media item then queue it up in the playlist for the service provider to play.

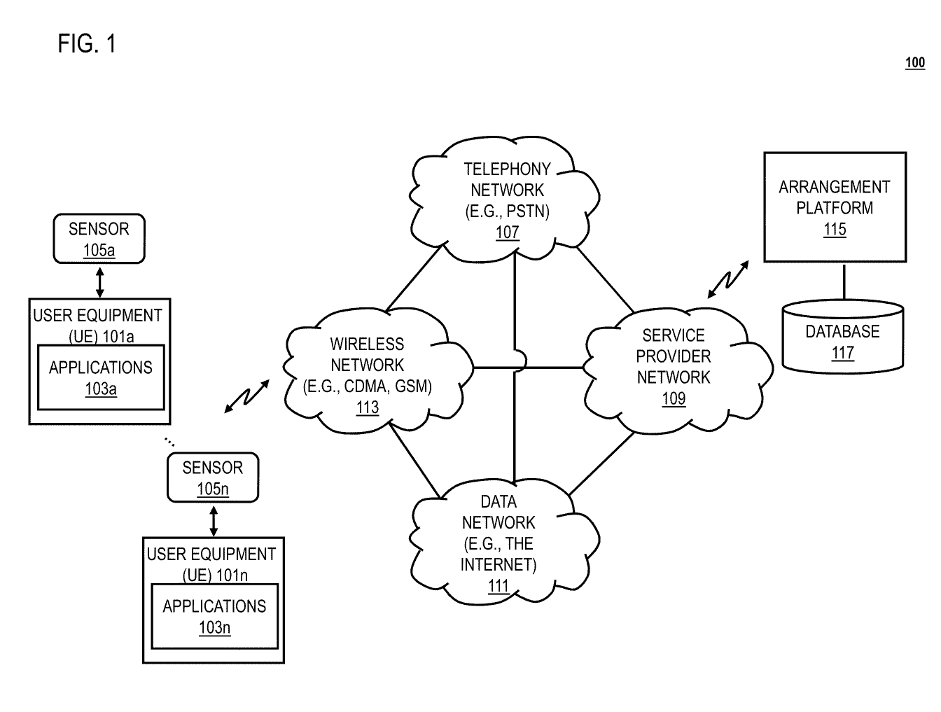

As shown in FIG. 1, the system 100 comprises user equipment (UE) 101a-101n (collectively referred to as UE 101) that may include or be associated with applications 103a-103n (collectively referred to as applications 103) and sensors 105a-105n (collectively referred to as sensors 105). In one embodiment, the UE 101 has connectivity to the arrangement platform 115 via networks 107-113.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the applications 103 may be any type of application that is executable at the UE 101, such as media player applications, social networking applications, calendar applications, content provisioning services, location-based service applications, and the like. In one embodiment, one of the applications 103 at the UE 101 may act as a client for the arrangement platform 115 and may perform one or more functions associated with the functions of the arrangement platform 115 by interacting with the arrangement platform 115 over the networks 107-113.

By way of example, the sensors 105 may be any type of sensor. In certain embodiments, the sensors 105 may include, for example, a network detection sensor for detecting wireless signals or receivers for different short-range communications (e.g., Bluetooth, Wi-Fi, Li-Fi, near field communication etc.), temporal information, a camera/imaging sensor for gathering image data, an audio recorder for gathering audio data, a global positioning sensor for gathering location data (e.g., GPS), and the like.

For illustrative purposes, the networks 107-113 may be any suitable wireline and/or wireless network, and be managed by one or more service providers. For example, telephony network 107 may include a circuit-switched network, such as the public switched telephone network (PSTN), an integrated services digital network (ISDN), a private branch exchange (PBX), or other like network. Wireless network 113 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (Wi-Fi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 107-113 may be completely or partially contained within one another, or may embody one or more of the aforementioned infrastructures. For instance, the service provider network 109 may embody circuit-switched and/or packet-switched networks that include facilities to provide for transport of circuit-switched and/or packet-based communications. It is further contemplated that networks 107-113 may include components and facilities to provide for signaling and/or bearer communications between the various components or facilities of system 100. In this manner, networks 107-113 may embody or include portions of a signaling system 7 (SS7) network, or other suitable infrastructure to support control and signaling functions.

In one embodiment, the arrangement platform 115 may be a platform with multiple interconnected components. The arrangement platform 115 may include multiple servers, intelligent networking devices, computing devices, components and corresponding software for organizing media items in a playlist for playback on the first device based on selection of media items in the second device by one or more users. In addition, it is noted that the arrangement platform 115 may be a separate entity of the system 100, or included within the UE 101 (e.g., as part of the applications 103).

In one embodiment, the arrangement platform 115 may generate a playlist of one or more media items for playback on a first device. In one scenario, the arrangement platform 115 may create a playlist for one or more songs, one or more videos, etc. The playlist may be presented to one or more users in the at least one second device, wherein the users may provide feedback for playback on the at least one first device.

In one embodiment, the arrangement platform 115 may initiate a preview of the one or more media items, one or more other media items, or a combination thereof on one or more second devices, wherein the one or more second devices control a streaming of the playlist to the first device. In one scenario, a user may select one or more media items from the playlist from a second device. The user may pre-listen or preview one or more media items, and may choose the media items as a subsequent media item to the currently played media item.

In one embodiment, the arrangement platform 115 may receive a voting input for identifying a selected media item from among the one or more media items, the one or more other media items, or a combination thereof based on the preview. In one scenario, the arrangement platform 115 may rank the media item in the playlist based on user selection. The arrangement platform 115 may increase or decrease the ranking of media items in the playlist based on user selection, voting information, or a combination thereof. The media items ranked higher are given preference over the media items ranked lower.

In one embodiment, the arrangement platform 115 may modify the playlist for playback on the first device based on the selected media item. In one scenario, the arrangement platform 115 may provide the at least one first device with an updated playlist. Then, the first device may cause a rendering the one or more media items in the playlist based on their ranking In one example embodiment, the ranking of one or more media items represents the preference information of one or more users. As a result, the at least one first device may play the media item in a chronological order.

In one embodiment, media items of various formats, for example, music files in MP3 formats may be stored in the database 117 for a user to access, select and play subsequently. In another embodiment, the database 117 may store profiles of users of the applications 103. The profile of a user may include, but is not restricted to, user history, user preference information, user equipment type and capabilities, and the like.

According to exemplary embodiments, end user devices may be utilized to communicate over system 100 and may include any customer premise equipment (CPE) capable of sending and/or receiving information over one or more of networks 107-113. For instance, voice terminal may be any suitable plain old telephone service (POTS) device, facsimile machine, etc., whereas mobile device (or terminal) may be any cellular phone, radiophone, satellite phone, smart phone, wireless phone, or any other suitable mobile device, such as a personal digital assistant (PDA), pocket personal computer, tablet, customized hardware, etc. Further, computing device may be any suitable computing device, such as a VoIP phone, skinny client control protocol (SCCP) phone, session initiation protocol (SIP) phone, IP phone, personal computer, softphone, workstation, terminal, server, etc.

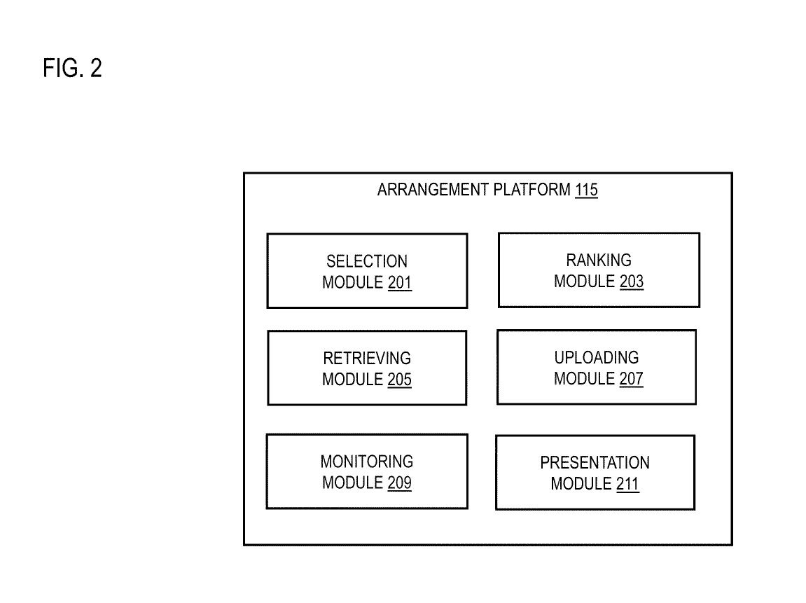

FIG. 2 is a diagram of the components of the arrangement platform 115, according to one embodiment. By way of example, the arrangement platform 115 includes one or more components for organizing media items in a playlist based on user selection. It is contemplated that the functions of these components may be combined in one or more components or performed by other components of equivalent functionality. In this embodiment, the arrangement platform 115 includes a selection module 201, a ranking module 203, a retrieving module 205, an uploading module 207, a monitoring module 209, and a presentation module 211.

In one embodiment, the selection module 201 may select a media item from the playlist as a subsequent media item to a currently played media item based on user interaction. In one scenario, a media selection request may be provided by a user via a touch-based interaction, a gesture-based interaction, an audio interaction, or a combination thereof via at least one second device. In another embodiment, the selection of the media item include pre-listening the media items in at least one second device, and approving the media items from the second device, replacing the media items with other preferred media items from the second device, or a combination thereof.

In one embodiment, the ranking module 203 may rank the media items in the playlist based on the selection. In another embodiment, the ranking module 203 may cause an increase, a decrease, or a combination thereof in the ranking of the media items in the playlist based on the voting information, the user preference information, the user history information, or a combination thereof. In a further embodiment, the media items ranked higher may be given preference over the media items ranked lower.

In one embodiment, the retrieving module 205 may retrieve one or more media items from a third party media streaming service based on a determination that the media items of user's interest is not available in the playlist. In one scenario, the retrieving module 205 may process user requests, user preference information, user history information, or a combination thereof to determine media items of users' preference. Then, the arrangement platform 115 may process database 117 to determine the existence of media items of users' preference. In not, the retrieving module 205 may retrieve the media items of user's interest from a third party media streaming service.

In one embodiment, the uploading module 207 may upload plurality of media items via mobile devices associated with one or more users, third party content providers, or a combination thereof. In one scenario, one or more users may upload songs, videos, etc. of their choice from their respective UE 101. In another scenario, the one or more users may upload songs, videos, etc. of their choice from the third party content providers. Then, the arrangement platform 115 may accommodate the songs, videos, etc. in the playlist. The one or more other users may vote for the uploaded media items via at least one second device to cause a ranking, a rendering, or a combination thereof.

In one embodiment, the monitoring module 209 may monitor user preference information, the historical user information, or a combination thereof to determine media items for one or more users. Then, the monitoring module 209 may update the playlist for one or more media items based on the changes in the user preference information, the historical user information, or a combination thereof.

In one embodiment, the presentation module 211 may present a playlist for one or more media items in at least one second mobile device. In one scenario, the playlist for one or more media items includes title information, category information, duration information, or a combination thereof. In another scenario, the one or more media items in the playlist include video content, audio content, image content, or a combination thereof. In another embodiment, the presentation module 211 may render a preview of the selected media item in at least one second device from the playlist. In a further embodiment, the presentation module 211 may employ various application programming interfaces (APIs) or other function calls corresponding to the applications 103 of UE 101, thus enabling the display of graphics primitives such as menus, data entry fields, etc., for generating the user interface elements. In a further scenario, the presentation module 211 obtains a set of summary statistics from other modules. Then, the module continues with generating a presentation corresponding to the playlist of user preferred media items. Subsequently, the module continues with providing a presentation of data set where the presentation could be depicted in one or more visual display units.

The above presented modules and components of the arrangement platform 115 can be implemented in hardware, firmware, software, or a combination thereof. Though depicted as a separate entity in FIG. 1, it is contemplated that the arrangement platform 115 may be implemented for direct operation by respective UE 101. As such, the arrangement platform 115 may generate direct signal inputs by way of the operating system of the UE 101 for interacting with the applications 103. In another embodiment, one or more of the modules 201-211 may be implemented for operation by respective UEs, as the arrangement platform 115. Still further, the arrangement platform 115 may be integrated for direct operation with network services provided by networks 107-113, such as in the form of a widget or applet, in accordance with an information and/or subscriber sharing arrangement. The various executions presented herein contemplate any and all arrangements and models.

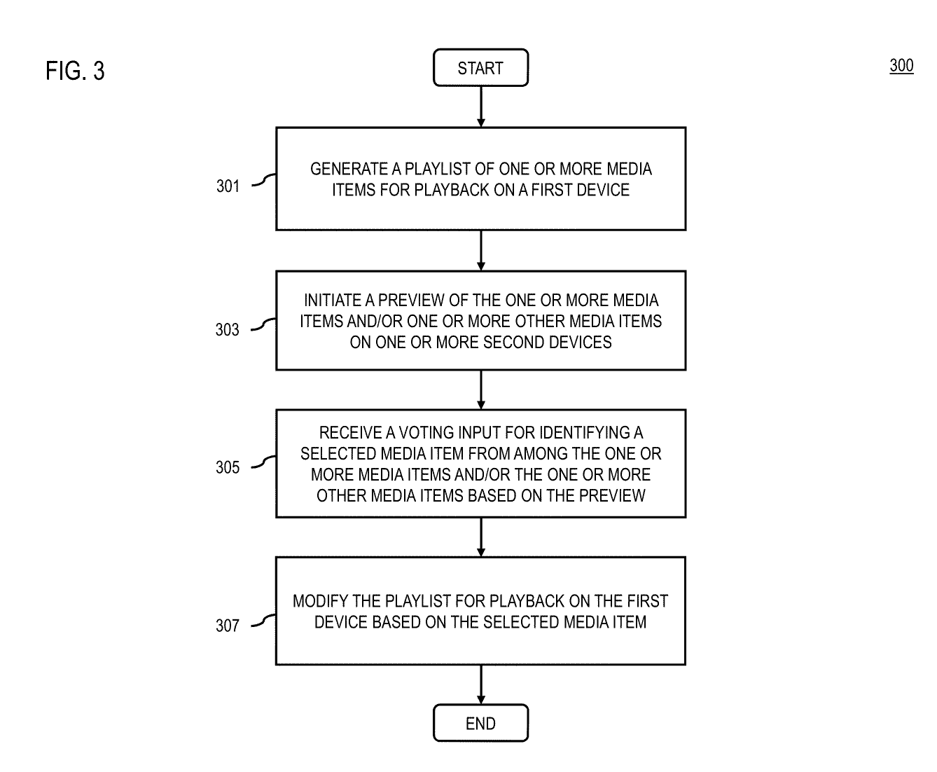

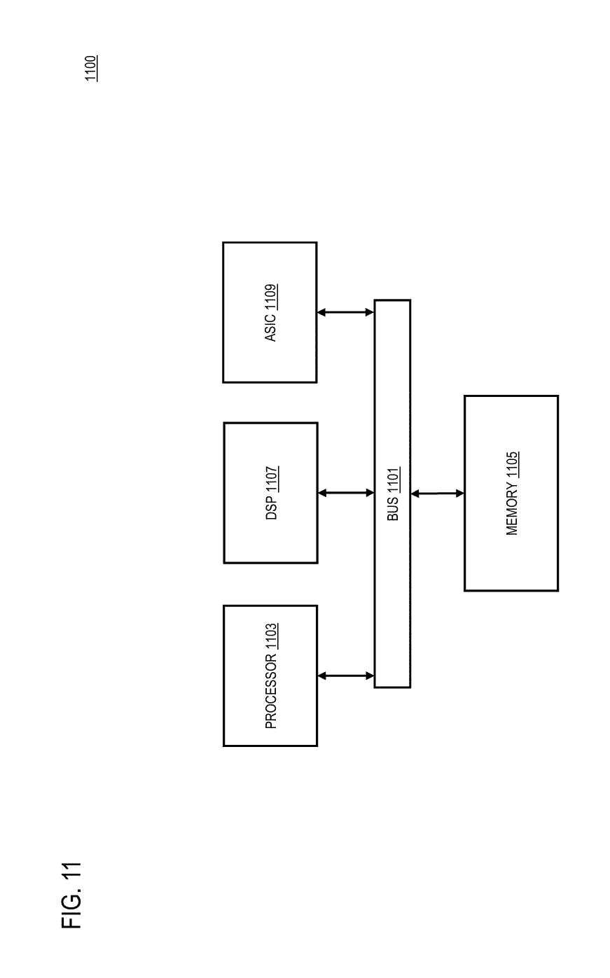

FIG. 3 is a flowchart of a process for providing preview of media items in a second device for receiving an input for identifying media items for playback on the first device, according to one embodiment. In one embodiment, the arrangement platform 115 performs the process 300 and is implemented in, for instance, a chip set including a processor and a memory as shown in FIG. 11.

In step 301, the arrangement platform 115 may generate a playlist of one or more media items for playback on a first device. In one scenario, the arrangement platform 115 may create a list of songs for a user based, at least in part, on user preference information, user activity information, or a combination thereof. The list may be presented to a user in at least one second device. Then, the user may select at least one song from the playlist as a subsequent song to a currently played song.

In step 303, the arrangement platform 115 may initiate a preview of the one or more media items, one or more other media items, or a combination thereof on one or more second devices, wherein the one or more second devices control a streaming of the playlist to the first device. In one embodiment, the one or more second devices are associated with a plurality of users. In one scenario, a user may pre-listen to one or more songs from the playlist in at least one second device. The user may select the songs of his preference from the playlist via at least one second device. Further, the user may remove or replace the songs with other preferred songs not in the playlist.

In step 305, the arrangement platform 115 may receive a voting input for identifying a selected media item from among the one or more media items, the one or more other media items, or a combination thereof based on the preview. In one scenario, one or more users may elect the songs of their interest from the playlist, whereupon the arrangement platform 115 may cause an increase or a decrease in the ranking of the song in the playlist based on user preference. In one embodiment, the input for identifying the selected media item further specifies a parameter for selecting a portion of the selected media item to playback, mixing the one or more media items, or a combination thereof. In one scenario, the media items in a playlist may include video content, audio content, image content, or a combination thereof. The arrangement platform 115 may cause a mix-and-match of the media items, for example, playing a video after playing music. In one scenario, the mix-and-match of media items may be based on the selection information.

In step 307, the arrangement platform 115 may modify the playlist for playback on the first device based on the selected media item. In one scenario, the arrangement platform 115 may rank the media items in a playlist based on the voting inputs received from the second device. In one scenario, voting inputs may be sent over a Short Message Service (SMS) or a Multimedia Messaging Service (MMS) messaging system to a phone number, long code or short code. The second device may control the streaming of the playlist to the first device wherein the modification of the playlist may be reflected. The media items ranked higher are given preference over the media items ranked lower.

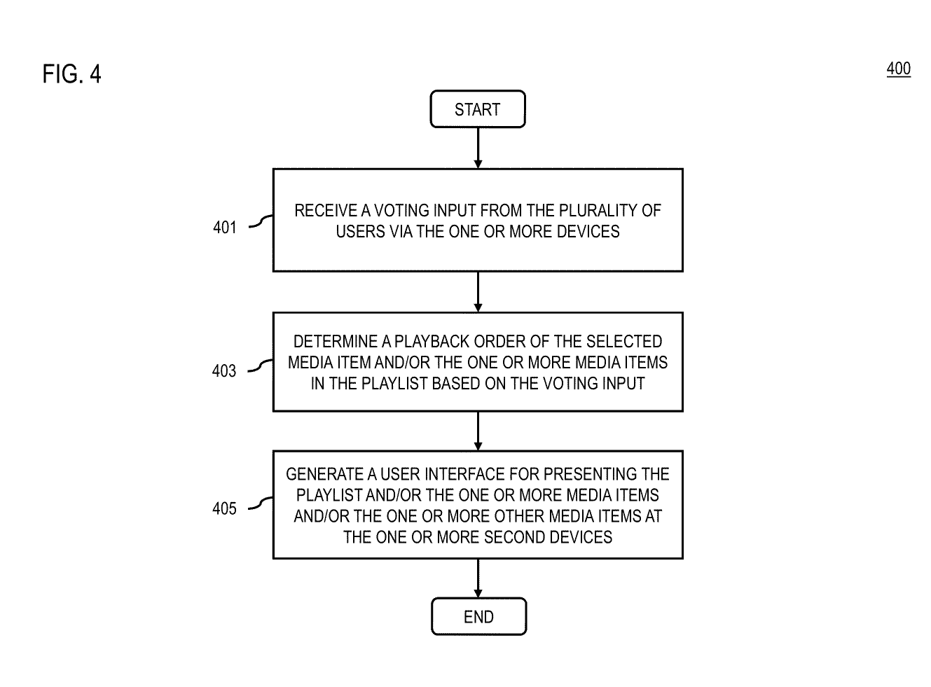

FIG. 4 is a flowchart of a process for determining playback order of media items in the playlist based on the voting input, according to one embodiment. In one embodiment, the arrangement platform 115 performs the process 400 and is implemented in, for instance, a chip set including a processor and a memory as shown in FIG. 11.

In step 401, the arrangement platform 115 may receive a voting input from the plurality of users via the one or more devices. In one scenario, the arrangement platform 115 may trigger a disc-jockey (i.e., DJ) mode, wherein a user may listen and choose a song that is going to be played next in at least one second device. In another scenario, if there are multiple users, the arrangement platform 115 may activate a social playlist, wherein the users may vote, remove or add songs from multiple sources (e.g., third party media service provider) to the playlist.

In step 403, the arrangement platform 115 may determine a playback order of the selected media item, the one or more media items, or a combination thereof in the playlist based on the voting input. In one scenario, the positioning of one or more media items in a playlist may be updated based on the voting information. For example, the songs that receive most votes may be ranked higher in the playlist. The playback order of the songs from the list may be in a descending order.

In step 405, the arrangement platform 115 may generate a user interface for presenting the playlist, the one or more media items, the one or more other media items, or a combination at the one or more second devices. In one scenario, the arrangement platform 115 may display a playlist in a second device for user input. The display of the playlist may include title information, category information, duration information, etc. for one or more media items. The user may select a media item, and may preview the media item.

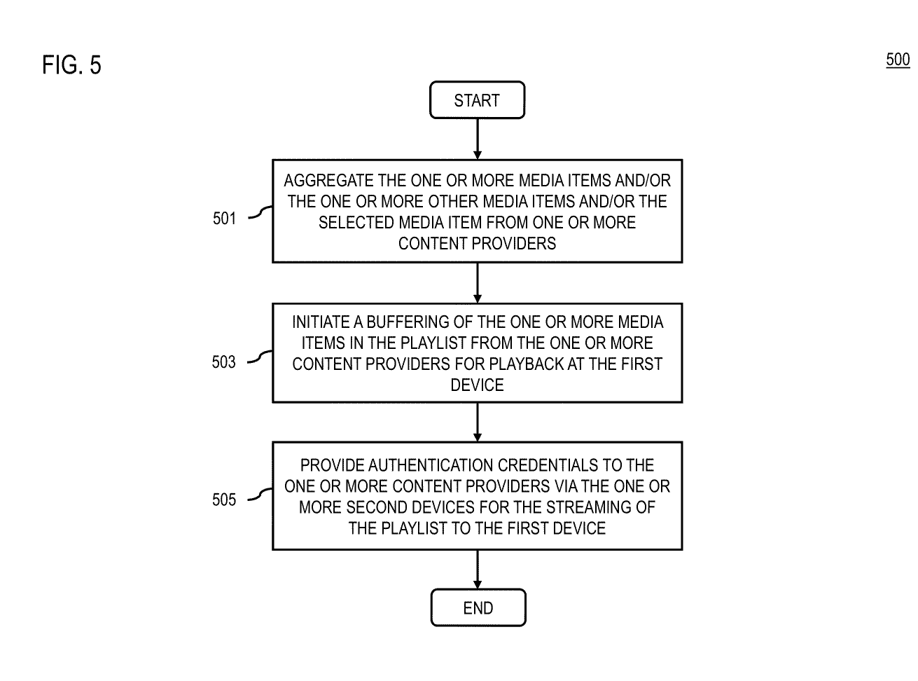

FIG. 5 is a flowchart of a process for collecting media items from one or more content providers, according to one embodiment. In one embodiment, the arrangement platform 115 performs the process 500 and is implemented in, for instance, a chip set including a processor and a memory as shown in FIG. 11.

In step 501, the arrangement platform 115 may aggregate the one or more media items, the one or more other media items, the selected media item or a combination thereof from one or more content providers. In one scenario, the arrangement platform 115 may collect various media items from a third party content provider. The collection of several media items may be based, at least in part, on user preference information, voting information, selection information, user activity information, or a combination thereof.

In step 503, the arrangement platform 115 may initiate a buffering of the one or more media items in the playlist from the one or more content providers for playback at the first device. In one scenario, buffering multiple media items may tax the performance of a system, as each buffered media items requires caching or storing of data locally. As a result, a video or audio file may experience performance disruptions. Therefore, the arrangement platform 115 may initiate an intelligent buffering of the selected media items in the playlist from the third party content providers. This improves the playback performance in the first device by providing a smooth listening and/or viewing of audio or video content.

In step 505, the arrangement platform 115 may provide authentication credentials to the one or more content providers via the one or more second devices for the streaming of the playlist to the first device. In one scenario, the arrangement platform 115 may cause a user verification process based, at least in part, on predefined values, wherein predefined values include, at least in part, a preset username and password, one or more identifiers, other authentication mechanisms, or a combination thereof. In one example embodiment, the arrangement platform 115 may provide device information for at least one first device via at least one second device for the streaming of the media items in the first device.

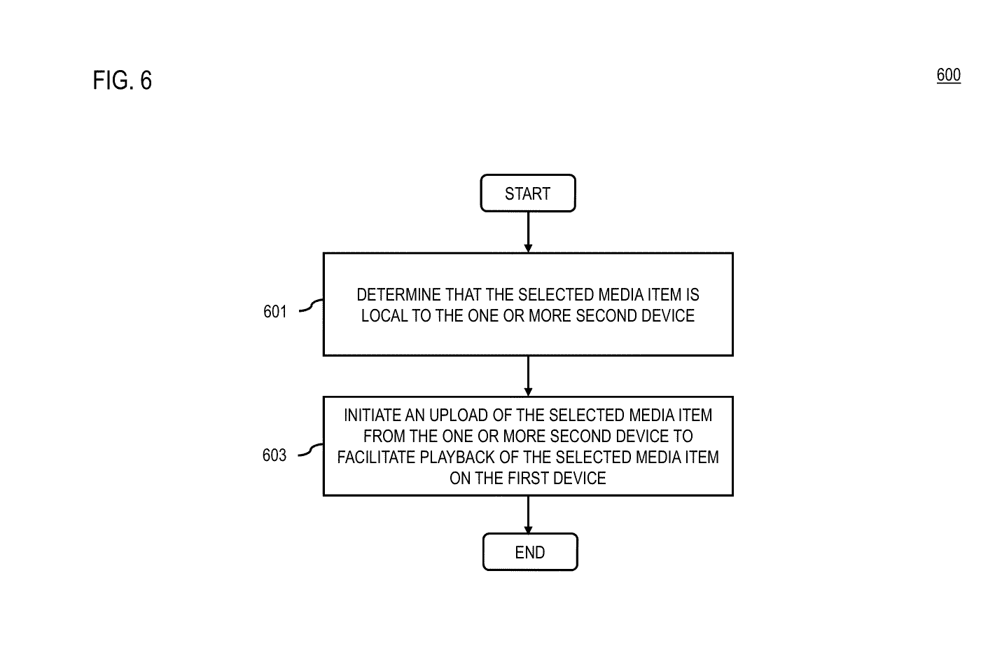

FIG. 6 is a flowchart of a process for uploading selected media item local to the second device to facilitate playback on the first device, according to one embodiment. In one embodiment, the arrangement platform 115 performs the process 600 and is implemented in, for instance, a chip set including a processor and a memory as shown in FIG. 11.

In step 601, the arrangement platform 115 may determine that the selected media item is local to the one or more second device. In one scenario, when a media item is selected for playback, the media item is retrieved from storage that is local to the second device (e.g., memory of the second device) for seamless media playback experience. For example, a locally stored media items may be immediately played upon selection for playback.

In step 603, the arrangement platform 115 may initiate an uploading of the selected media item from the one or more second device to facilitate playback of the selected media item on the first device. In one scenario, one or more media items that is local to the second device may be uploaded from the second device to the at least one first device. The one or more users may additionally vote for the uploaded items to cause a ranking, a rendering, or a combination thereof.

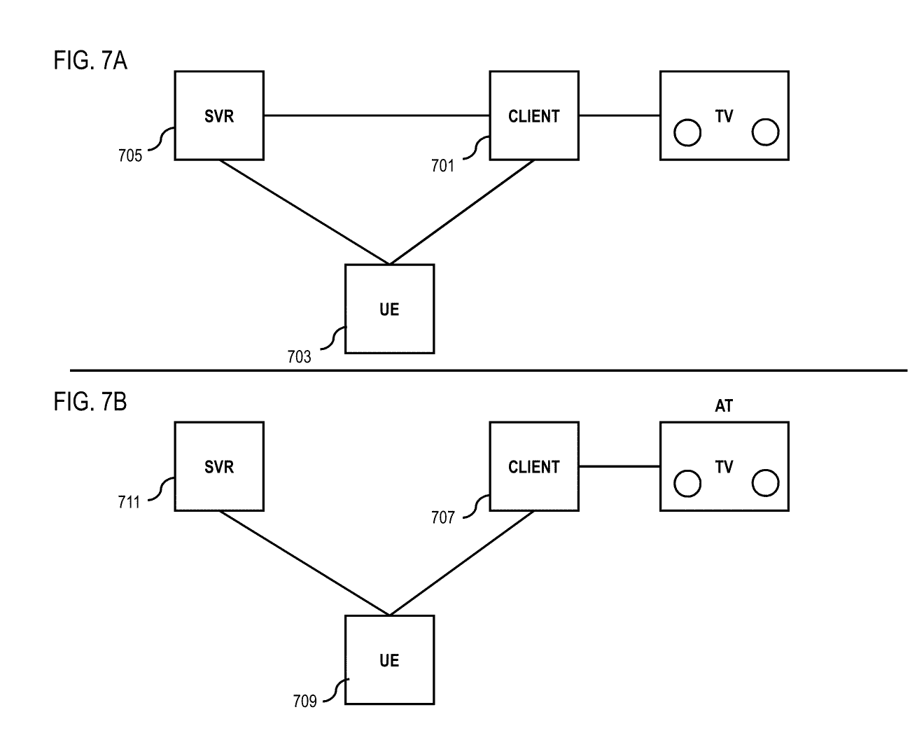

FIG. 7A is a diagram that represents a scenario wherein at least one user equipment maneuvers the ranking of certain media items in the playlist of a client device, according to one example embodiment. In one scenario, a client device [701] may be playing certain songs from its playlist. The user equipment [703] may process its database to find the songs in the playlist, and may communicate with the server [705] upon determining that the songs are unavailable in its database. The user equipment [703] may access the songs from the server [705] and plays it to the user. The user may pre-listen one or more songs from the playlist via his user equipment

without disrupting the song currently being played by the client device [701]. Then, the user may determine the subsequent song to the currently played song. Subsequently, the user equipment [703] may control the streaming of the playlist in the client device [701].

FIG. 7B is a diagram that represents a scenario wherein at least one user equipment controls the serving stream from the server to the client device, according to one example embodiment. In one scenario, the user equipment [709] may communicate with different content providers [711] to aggregate media items that are present in the playlist of the client device [707]. The user equipment [709] may stream the content directly from the content providers [711]. Then, the user equipment [709] may play the content into the client device [707]. The client device [707] may buffer the content and may play it back.

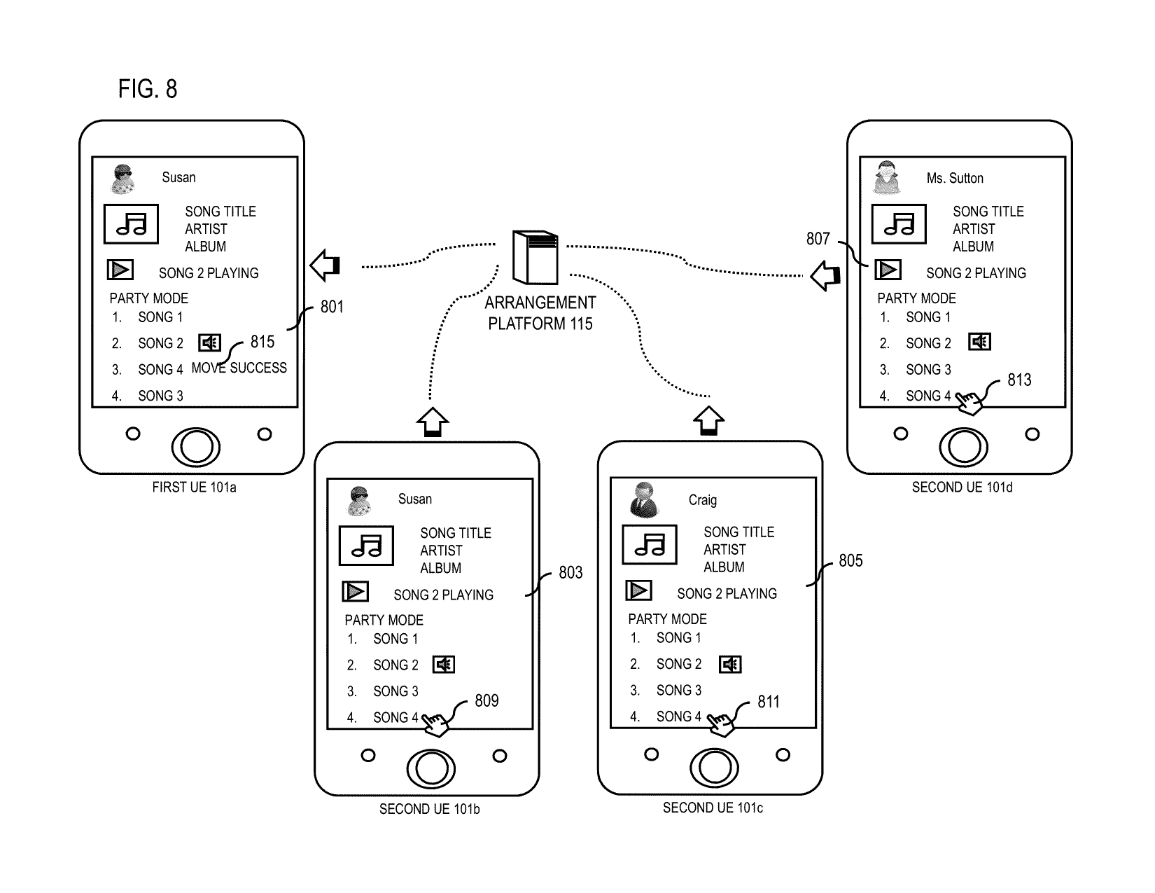

FIG. 8 is a user interface diagram that represents a scenario wherein media items are previewed in one or more second devices for modifying a playlist in the first device, according to one example embodiment. In one scenario, at least one first device UE 101a (e.g., a media device) may play songs from a playlist in a sequential manner. This process does not encompass the interest of users. Hence, one or more users present in an event may preview the songs in the playlist from one or more second devices (e.g., UE 101a, UE 101b, UE 101c). The second devices may generate a user interface for presenting the playlist [803, 805, 807]. The users may preview the songs from the playlist, and may vote for the songs per their preference [809, 811, 813]. This initiates modification of the playlist for playback on the first device (e.g., a media device). The changes in the ranking of the media items are reflected in the playlist for playback on the first device. For example, all users present in an event voted for song 4 in the playlist. Subsequently, the arrangement platform 115 upgrades the position of song 4 based on the voting information by replacing song 3 by song 4 [815].

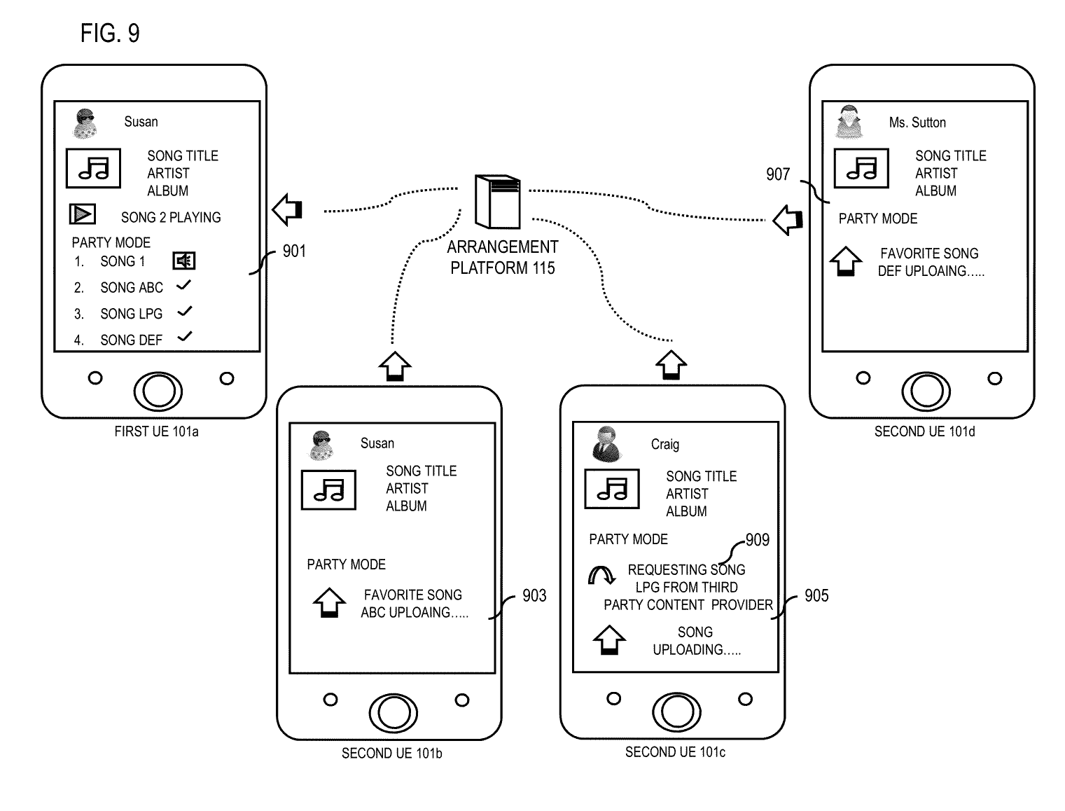

FIG. 9 is a user interface diagram that represents a scenario wherein media items of interest are uploaded from second devices to facilitate playback on the first device, according to one example embodiment. In one scenario, the arrangement platform 115 may create a social playlist, wherein multiple users attending an event may add their preferred media to the playlist. In one example embodiment, one or more users may upload their favorite songs [903, 905, 907] from one or more second devices [UE 101b, UE 101c, UE 101d]. Then, the arrangement platform 115 may add the songs to the playlist of the first device as the potential subsequent songs to the currently played song [901]. Subsequently, other users present in the event may vote (e.g., thumbs up, thumbs down) for the songs in the playlist. As discussed, the arrangement platform 115 may give preference to the song that receives higher votes, and may situate the song behind the currently played song. In another example embodiment, at least one second device [UE 101c] may stream favorite songs of its user from a third party content provider [909]. Then, the song may be uploaded to the playlist of the first device.

The computer system 1000 may be coupled via the bus 1001 to a display 1011, such as a cathode ray tube (CRT), liquid crystal display, active matrix display, or plasma display, for displaying information to a computer user. An input device 1013, such as a keyboard including alphanumeric and other keys, is coupled to the bus 1001 for communicating information and command selections to the processor 1003. Another type of user input device is a cursor control 1015, such as a mouse, a trackball, or cursor direction keys, for communicating direction information and command selections to the processor 1003 and for controlling cursor movement on the display 1011.

According to an embodiment of the invention, the processes described herein are performed by the computer system 1000, in response to the processor 1003 executing an arrangement of instructions contained in main memory 1005. Such instructions can be read into main memory 1005 from another computer-readable medium, such as the storage device 1009. Execution of the arrangement of instructions contained in main memory 1005 causes the processor 1003 to perform the process steps described herein. One or more processors in a multi-processing arrangement may also be employed to execute the instructions contained in main memory 1005. In alternative embodiments, hard-wired circuitry may be used in place of or in combination with software instructions to implement the embodiment of the invention. Thus, embodiments of the invention are not limited to any specific combination of hardware circuitry and software. The computer system 1000 may further include a Read Only Memory (ROM) 1007 or other static storage device coupled to the bus 1001 for storing static information and instructions for the processor 1003.

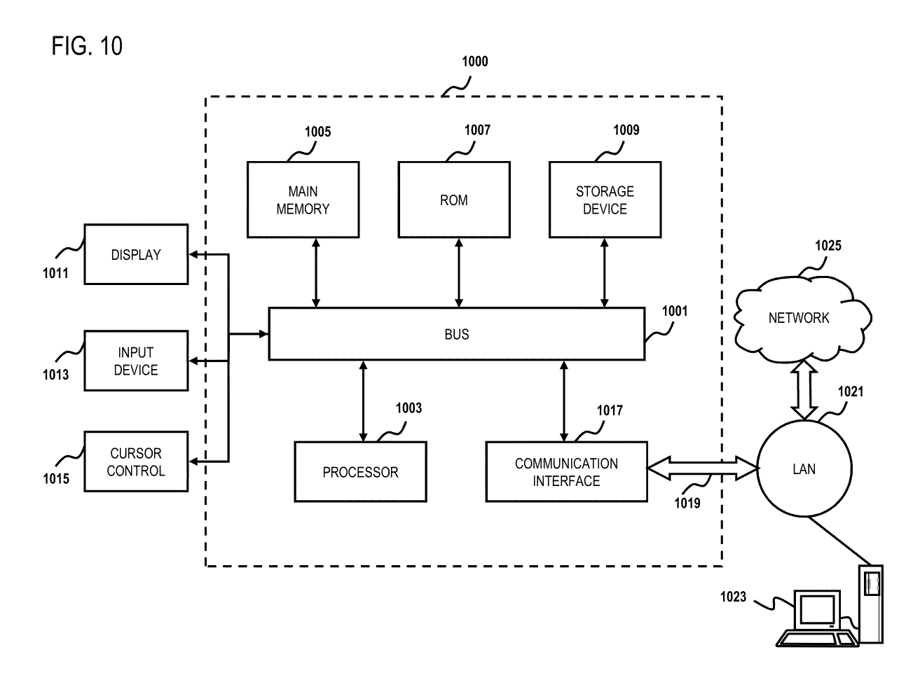

The computer system 1000 also includes a communication interface 1017 coupled to bus 1001. The communication interface 1017 provides a two-way data communication coupling to a network link 1019 connected to a local network 1021. For example, the communication interface 1017 may be a digital subscriber line (DSL) card or modem, an integrated services digital network (ISDN) card, a cable modem, a telephone modem, or any other communication interface to provide a data communication connection to a corresponding type of communication line. As another example, communication interface 1017 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1017 sends and receives electrical, electromagnetic, or optical signals that carry digital data streams representing various types of information. Further, the communication interface 1017 can include peripheral interface devices, such as a Universal Serial Bus (USB) interface, a PCMCIA (Personal Computer Memory Card International Association) interface, etc. Although a single communication interface 1017 is depicted in FIG. 10, multiple communication interfaces can also be employed.

The network link 1019 typically provides data communication through one or more networks to other data devices. For example, the network link 1019 may provide a connection through local network 1021 to a host computer 1023, which has connectivity to a network 1025 (e.g. a wide area network (WAN) or the global packet data communication network now commonly referred to as the “Internet”) or to data equipment operated by a service provider. The local network 1021 and the network 1025 both use electrical, electromagnetic, or optical signals to convey information and instructions. The signals through the various networks and the signals on the network link 1019 and through the communication interface 1017, which communicate digital data with the computer system 1000, are exemplary forms of carrier waves bearing the information and instructions.

The computer system 1000 can send messages and receive data, including program code, through the network(s), the network link 1019, and the communication interface 1017. In the Internet example, a server (not shown) might transmit requested code belonging to an application program for implementing an embodiment of the invention through the network 1025, the local network 1021 and the communication interface 1017. The processor 1003 may execute the transmitted code while being received and/or store the code in the storage device 1009, or other non-volatile storage for later execution. In this manner, the computer system 1000 may obtain application code in the form of a carrier wave.

The term “computer-readable medium” as used herein refers to any medium that participates in providing instructions to the processor 1003 for execution. Such a medium may take many forms, including but not limited to non-volatile media, volatile media, and transmission media. Non-volatile media include, for example, optical or magnetic disks, such as the storage device 1009. Volatile media include dynamic memory, such as main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 11 illustrates a chip set 1100 upon which an embodiment of the invention may be implemented. Chip set 1100 is programmed to present a slideshow as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1100, or a portion thereof, constitutes a means for performing one or more steps of FIGS. 3-6.

In one embodiment, the chip set 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1105 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
generating a playlist of one or more media items for playback on a first device;
initiating a preview of the one or more media items, one or more other media items, or a combination thereof on one or more second devices, wherein the one or more second devices control a streaming of the playlist to the first device;
receiving a voting input for identifying a selected media item from among the one or more media items, the one or more other media items, or a combination thereof based on the preview; and
modifying the playlist for playback on the first device based on the selected media item.

2. A method of claim 1, wherein the one or more second devices are associated with a plurality of users.

3. A method of claim 2, further comprising:
receiving a voting input from the plurality of users via the one or more devices; and
determining a playback order of the selected media item, the one or more media items, or a combination thereof in the playlist based on the voting input.

4. A method of claim 2, further comprising:
generating a user interface for presenting the playlist, the one or more media items, the one or more other media items, or a combination thereof at the one or more second devices.

5. A method of claim 1, further comprising:
aggregating the one or more media items, the one or more other media items, the selected media item or a combination thereof from one or more content providers.

6. A method of claim 5, further comprising:
initiating a buffering of the one or more media items in the playlist from the one or more content providers for playback at the first device.

7. A method of claim 5, further comprising:
providing authentication credentials to the one or more content providers via the one or more second devices for the streaming of the playlist to the first device.

8. A method of claim 1, further comprising:
determining that the selected media item is local to the one or more second device; and
initiating an upload of the selected media item from the one or more second device to facilitate playback of the selected media item on the first device.

9. A method of claim 1, wherein the input for identifying the selected media item further specifies a parameter for selecting a portion of the selected media item to playback, mixing the one or more media items, or a combination thereof.

10. An apparatus comprising a processor configured to:
generate a playlist of one or more media items for playback on a first device;
initiate a preview of the one or more media items, one or more other media items, or a combination thereof on one or more second devices, wherein the one or more second devices control a streaming of the playlist to the first device;
receive a voting input for identifying a selected media item from among the one or more media items, the one or more other media items, or a combination thereof based on the preview; and
modify the playlist for playback on the first device based on the selected media item.

11. An apparatus of claim 10, wherein the one or more second devices are associated with a plurality of users.

12. An apparatus of claim 11, further comprising:
receive a voting input from the plurality of users via the one or more devices; and
determine a playback order of the selected media item, the one or more media items, or a combination thereof in the playlist based on the voting input.

13. An apparatus of claim 11, further comprising:
generate a user interface for presenting the playlist, the one or more media items, the one or more other media items, or a combination thereof at the one or more second devices.

14. An apparatus of claim 10, further comprising:
aggregate the one or more media items, the one or more other media items, the selected media item or a combination thereof from one or more content providers.

15. An apparatus of claim 14, further comprising:
initiate a buffering of the one or more media items in the playlist from the one or more content providers for playback at the first device.

16. An apparatus of claim 14, further comprising:
provide authentication credentials to the one or more content providers via the one or more second devices for the streaming of the playlist to the first device.

17. A system comprising a platform configured to:
generate a playlist of one or more media items for playback on a first device;
initiate a preview of the one or more media items, one or more other media items, or a combination thereof on one or more second devices, wherein the one or more second devices control a streaming of the playlist to the first device;
receive a voting input for identifying a selected media item from among the one or more media items, the one or more other media items, or a combination thereof based on the preview; and
modify the playlist for playback on the first device based on the selected media item.

18. A system of claim 17, wherein the one or more second devices are associated with a plurality of users.

19. A system of claim 18, wherein the platform is further configured to:
receive a voting input from the plurality of users via the one or more devices; and
determine a playback order of the selected media item, the one or more media items, or a combination thereof in the playlist based on the voting input.

20. A system of claim 18, wherein the platform is further configured to:
generate a user interface for presenting the playlist, the one or more media items, the one or more other media items, or a combination thereof at the one or more second devices.
